(19) United States
(12) Patent Application Publication
(10) Pub. No.: US 2004/0028830 A1
(43) Pub. Date: Feb. 12, 2004

(54) Method, system and device for the production of components with a pre-determined surface appearance, in particular for front panels of kitchen units

(76) Inventor: Jorg R. Bauer, Weingarten (DE)

Correspondence Address: Rorbert W Becker, Robert W Becker & Associates, Suite B, 707 Highway 66 East, Tijeras, NM, 87059, US

(21) Appl. No.: 10/312,601

(22) PCT Filed: Jun. 25, 2001
(86) PCT No.: PCT/EP01/07159

(30) Foreign Application Priority Data
Jun. 26, 2000 (DE) 100 31 030.3

(51) Int. Cl. B05D 1/02; B05C 5/00

(52) U.S. Cl. 427/421; 427/256; 118/300; 118/305

(57) ABSTRACT

The invention relates to a method for the production of components with a pre-determined surface appearance, in particular for front panels of kitchen units, whereby the components are printed with a pre-determined pattern by means of a printing method which may be programmed corresponding to the appearance achieved. The invention further relates to a device for the production of said components and a system in which groups of said components are produced.

The invention relates to a method, an apparatus, and a system for producing components with a predetermined outer surface appearance, especially, front panels of kitchen units.

A construction feature of conventional kitchens resides in the fact that various kitchen units, drawers, closets, electrical devices, and so forth are provided with front panels which lend a unique and pleasant outer appearance to the kitchen. The variety of front panel sizes and the variety of outer surfaces desired by the customers, which comprise various types of wood, synthetic material outer surfaces, colors and patterns, leads to an extraordinarily cost intensive production with a large inventory. For example, front panels are produced from various large woods or with various wood veneers, which are then stained or pickled in the desired color and the outer surfaces thereof are then sealed.

The invention provides a solution to the challenge of ameliorating the above-noted problems.

The method characterized in claim 1 provides a solution for the above-noted problem.

In accordance with the inventive method, components having various outer appearances can be produced from form pieces, whose form corresponds to the components to be produced, although the printed form pieces use the same outer surfaces or form pieces which, from the perspective of their outer surface materials, comprise a substantially reduced variety of pieces as compared to the variety of the printed components which are to be produced. For example, it is possible to achieve an extraordinarily large variety of components by working with only two types of form pieces of outer surfaces. The one type of form piece comprises a synthetic material outer surface, and the other type of form piece comprises a wood veneer outer surface. The various colors and/or patterns can be printed on the synthetic material outer surfaces in order to produce a corresponding outer appearance. Various wood grain appearances can be printed on the wood veneer outer surfaces which produce the appearance of various types of wood with various colorings without actually having to use the respective actual type of wood. Surprisingly, it has been shown that the base grain appearance of the veneer outer surface or, as well, of a full wood outer surface, does not contrast with an imprint of other grain patterns and, via corresponding specification of the color intensity, the outer appearances of the imprinted grain pattern are not disadvantageously influenced thereby. It is possible with the inventive method to produce an extraordinarily high variety of outer appearances—that is, to produce appearances in the variety desired by customers with a low variety of raw material pieces.

The dependent claims 2 through 6 are directed to advantageous practical embodiments of the inventive method.

In accordance with the features in claim 7, the outer surfaces to be imprinted can be handled such that the outer surfaces are able to receive in a good manner those color liquors which, because of the employed color process such as, for example, an ink jet print process, are subjected to certain limitations. In this manner, the outer surfaces to be imprinted and the color liquors can be coordinated with one another. In connection with wood outer surfaces, a pre-handling thereof can also include treating the wood in a predetermined manner in the form of a laser treatment such that its porosity or, respectively, its fluid receipt characteristic, can be adjusted to the employed print process or can include providing the wood with a specified base tone.

In accordance with the features in claim 8, the imprinted outer surface can be sealed or can be provided with other coatings which can, for example, be mechanically highly insensitive, which do not permit the passage therethrough of UV light, and so forth.

A further solution of the inventive challenge is achieved with an apparatus in accordance with claim 9.

The dependent claims 10 through 15 are directed to advantageous further configurations and embodiments of the inventive apparatus.

Claim 16 characterizes the basic configuration of a system for solving the inventive challenge.

With the inventive system, it is possible to achieve, in either a fully automatic or substantially automatic manner, an extraordinarily high variety of customer-desired appearances without necessitating the stocking of a cost-intensive inventory storage with more highly finished, and therefore more expensive, components. Via the inventive system, a much more practical “just in time” process for ordering is produced.

The invention is employable in numerous settings wherein the components, with regard to their outer appearances, should be accommodated in a reduced cost manner to a high variety of customer wishes. It is especially advantageous that the invention is employable with planar components in connection with which the planar-type raw material is initially cut into a predetermined form which then receives the desired outer surface appearance. An area for deploying the invention for which the present invention is particularly suited is the furniture industry in which furniture such as, for example, kitchen furniture, is assembled from planar components which should have different inner and outer appearances, whereby, in particular, the appearance on the outer side thereof must be, to a large degree, accommodated to individual customer desires and must be produced with high quality.

The invention is described in the hereinafter following schematic drawings and is explained with the further individual details.

The drawings show:

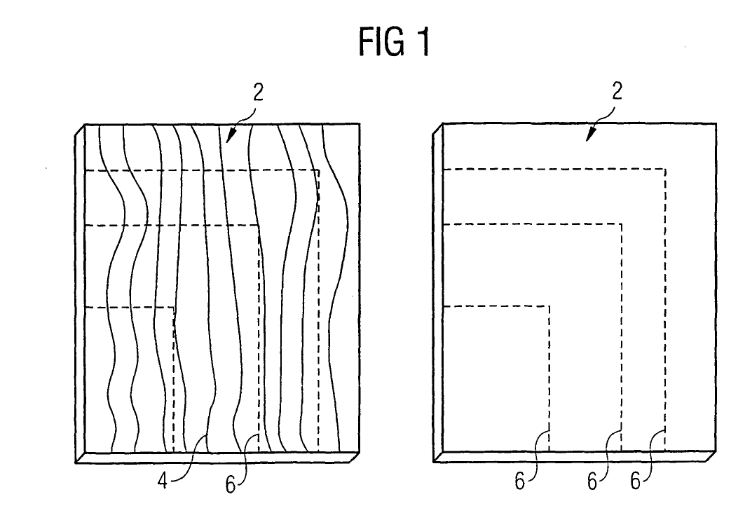

FIG. 1 a view of two front panels with differing outer surface structures,

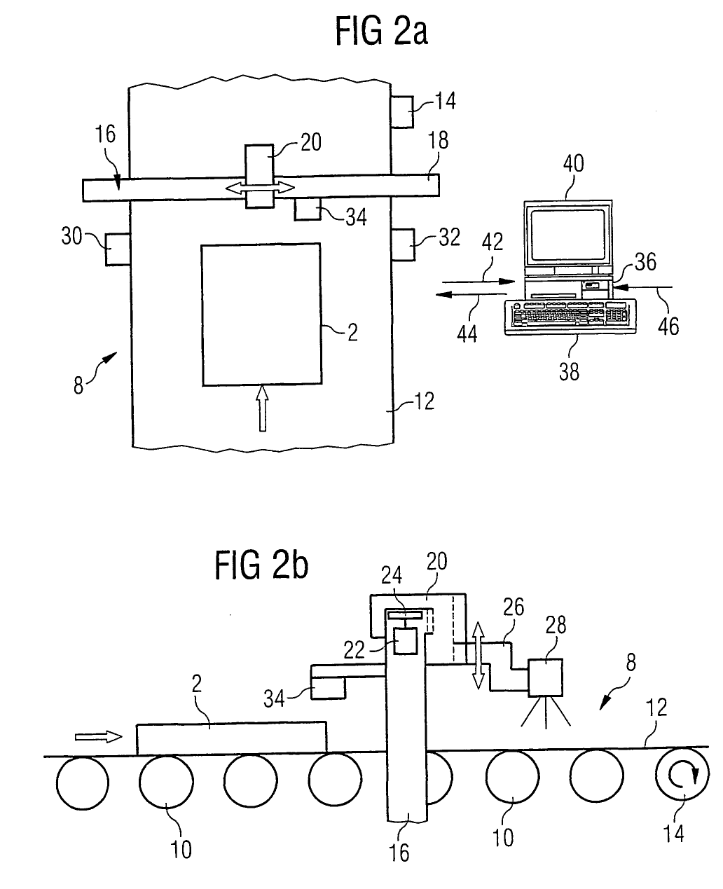

FIG. 2 a schematic view of an inventive apparatus,

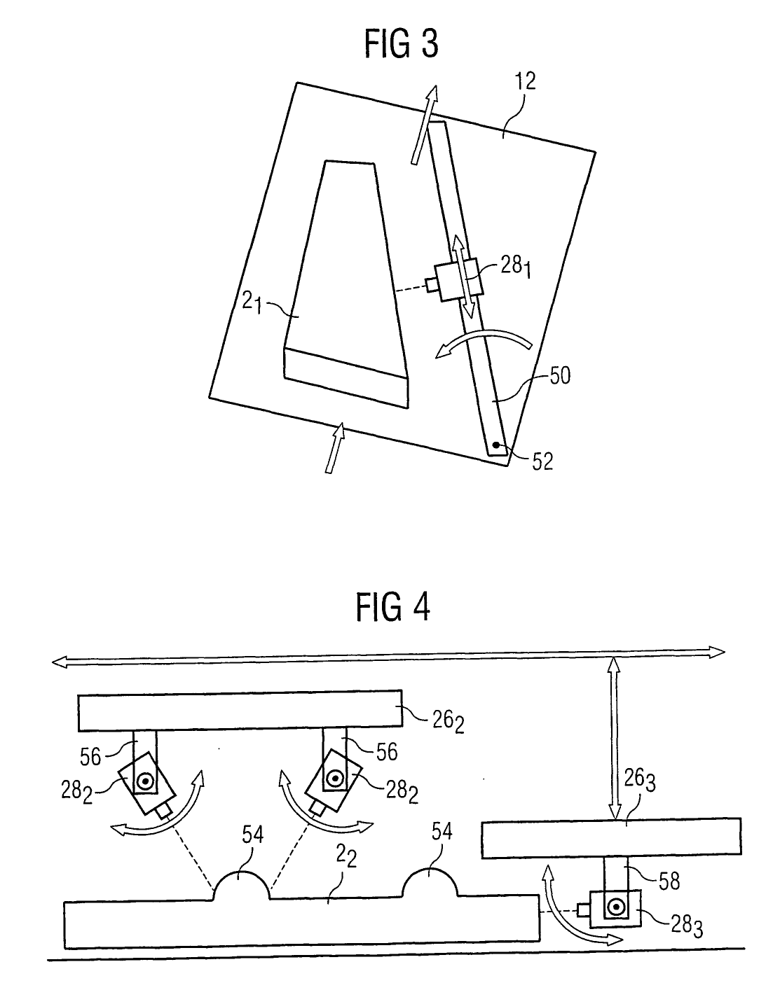

FIG. 3 a schematic view of a group of components comprised in the inventive apparatus,

FIG. 4 an example of further component groups comprised in the inventive apparatus,

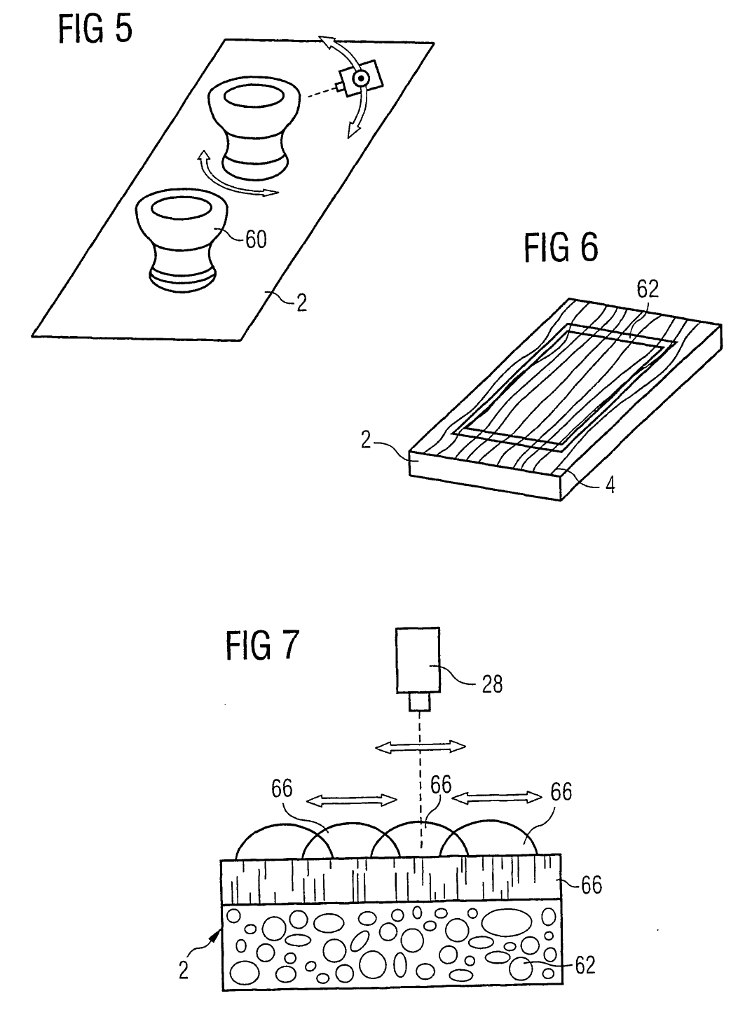

FIG. 5 a detail of the apparatus for imprinting hand knobs,

FIG. 6 a front panel having a decor provided thereon,

FIG. 7 a sectional view through a front panel for illustrating the imprinting,

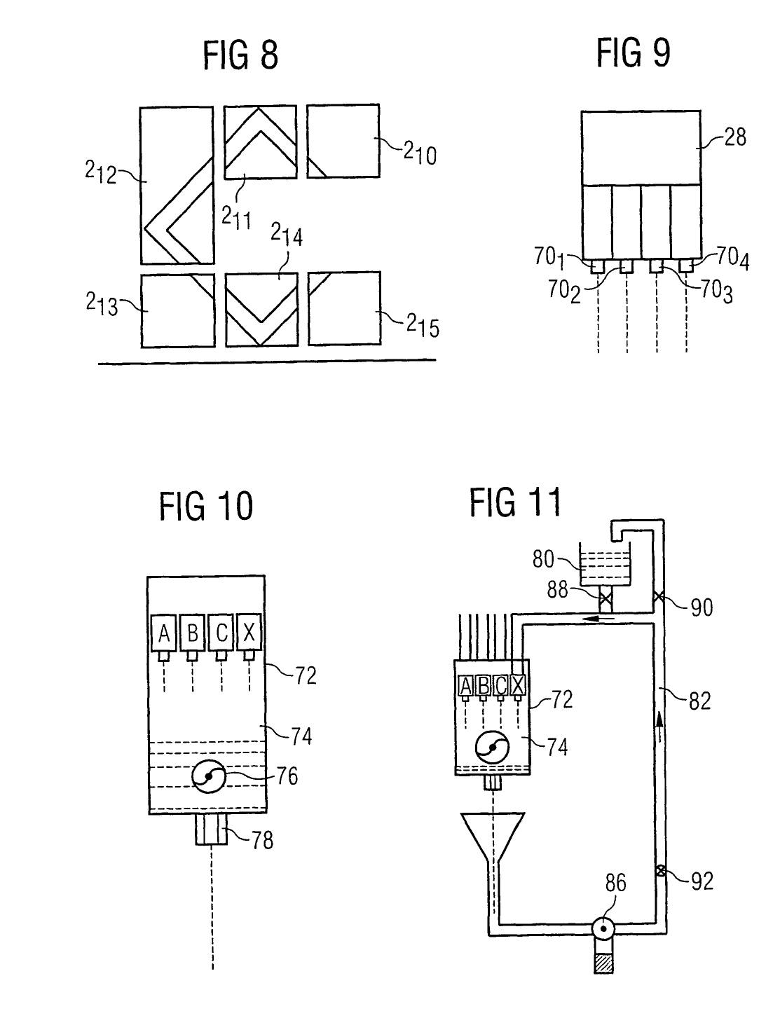

FIG. 8 a group of front panels,

FIG. 9 a schematic sectional view through a printing head,

FIG. 10 a schematic sectional view through a modified embodiment of a printing head,

FIG. 11 a view of the printing head shown in FIG. 10 in a wash device and

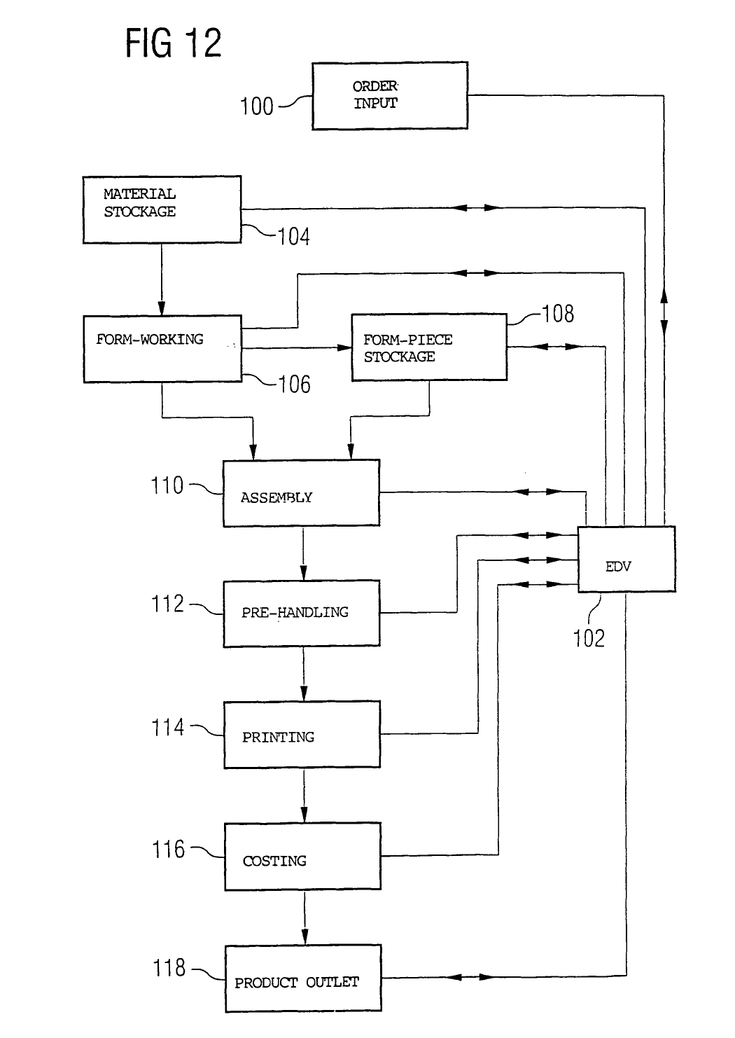

FIG. 12 a system for the production of front panels of an ordered kitchen unit.

FIG. 1 shows in exemplary manner two front panels 2, whereby the left front panel is provided with a wood outer surface with a grain pattern 4 and the right front panel has a homogeneous synthetic material outer surface. The front panels can have various configurations and outer surfaces such as, for example, a fiberboard base body on which a wood veneer is mounted, a synthetic material base body on which the material is bonded or laminated, so that the outer surface is structured in three dimensional manner, and so forth. The front panels can also be comprised of large wood.

The broken lines 6 are contour lines to illustrate that the front panels are required in various sizes, whereby non-right angled front panels, round and oval front panels, and so forth can be provided.

FIG. 2A shows in a plan view and FIG. 2B shows in a side view an apparatus for applying selected patterns on a front panel 2.

The front panel 2 is disposed on a transport device 8 which, for example, comprises a transport belt 12 trained over rollers or, respectively, shafts, 10, whose driving operation is provided by motor 14.

A portal 16 extends transversely over the transport belt 12 on whose transverse beam 18 a wagon 20 is movably guided longitudinally therealong. A motor 22 is provided to drive the wagon whose pinion 24 is threadably engaged with a tooth gear structure of the wagon 20.

A console 26 is perpendicularly displaceable by means of a not-illustrated drive in the direction of the double arrow (FIG. 2B) on the wagon 20, the console having mounted on its end a printing head 28 which is, for example, configured as a type of printing head such as the type used in ink jet printing or, respectively, ink jet or bubble-jet printing, whereby color spray nozzles of the printing head spray out color liquor drops.

To determine the position of the front panel 2, sensors 30, 32, and 34 are provided for sensing the contour and thickness of the front panel, whereby the sensor 30, for example, senses the forward edges of the front panel 2 which is transported on the transport belt 12, the sensor 32 senses the height of the front panel 2, and the sensor 34, which is supported on the transverse beam 18, senses the side edges of the front panel 2.

The sensors can operate ultrasonically or in another manner and can, additionally, be configured for movement so that the entire geometry of the outer surface of the front panel 2 can be respectively sensed before the outer surface comes into the region under the printing head 28.

The figures of the drawings do not show the color liquor supply and the color liquor charging for the printing head 22, which can be, for example, a large reservoir container arranged on the wagon 20.

A control device for controlling the apparatus is provided with a computer 36, a keyboard 38, and a screen 40. It is to be understood, that, additionally, a loudspeaker can be provided.

The sensors 30, 32, and 34 are connected to the inputs 42 of the computer 36; the drives for two dimensional movement (in transverse direction to the transport belt 12 and perpendicular to its outer surface) of the printing head 28, the control connectors for controlling the printing head 28 and, as the occasion warrants, the drives for movement of one or more of the sensors 30, 32, and 34, as well as the drive 14 for the transport belt 12, are connected to the outputs 44 of the computer.

Data is inputted via a further input 46, the data providing information concerning the pattern which is to be produced by the printing head 28. For the configuration of this pattern, all degrees of freedom are provided, whereby the pattern can be produced via scanning of picture patterns in digital form, storage of such scanned information, and then application of the pattern on the front panel 2 through corresponding control of the printing head 28 as well as control of its movement relative to the front panel 2 in connection with the control of the drive 14. With respect to the processing of the data, all modern technology is available such as, for example, that which is conventional with respect to present day photo printing.

The configuration and manner of working of the individual elements of the apparatus are conventionally known and are not further elaborated herein.

A front panel 2, which is disposed on the transport belt 12, is sensed by the sensors 30, 32, and 34, which sense the position and size of the front panel, so that the wagon 20 and the perpendicular drive of the console 26 as well as the drive of the printing head 28 can be controlled via the computer 36 in correspondence with the then currently effective pattern data in a manner such that the desired pattern is configured. If the entire contour of the front panel 2 has been sensed, this pattern configuration process is performed such that practically no color liquor is applied on the transport belt 12 and the outer surface of the front panel 2, including, as well, its edge regions, is completely imprinted.

The described apparatus can be modified in numerous ways. For example, if the geometry of the respective front panel is known and the front panel 2 is disposed on a respective reference position on the transport belt 12 and is oriented in a predetermined manner relative to the transport belt 12, it is only necessary to sense the front edges of the front panel 2 or, respectively, the location of the reference position relative to the transverse beam 18, so that the sensor effort is correspondingly reduced. The perpendicular movement capability of the printing head 28 is required for the reason that, in correspondence with the specification of the printing head 28 and the achievable detail level of the pattern, a predetermined spacing between the color spray nozzles of the printing head 20 and the outer surface of the front panel 2 to be imprinted is required.

The individually movable printing head shown in FIG. 2 having multiple color spray nozzles (not illustrated) for spraying out various color liquors can, for example, be replaced by spray beams arranged in serial manner relative to one another in the transport direction, these spray beams extending transversely over the transport belt 12 and each respectively comprising a row of color spray nozzles which are selectively controllable via the computer 36. The spray nozzles of the individual spray beams respectively spray only one color so that any pattern color can be produced with three serially arranged spray beams.

FIG. 3 shows, in perspective view, an advantageous detail of an additionally available printing device which may be required. In this printing device, the printing head 28 is longitudinally guidably moved along a support 50 in the direction of the double arrows and the support 50 is pivotable about a perpendicular axis 52 extending perpendicular to the direction of the double arrow. Additionally, the support 50 can be adjustably height movable or the printing head 28 can be adjustably height movable relative to the support 50.

With the apparatus it is possible, as can be directly seen, to print the side surfaces of the front panel 2 even if the side surfaces are inclined relative to the transport direction of the transport belt 12.

FIG. 4 shows further details of possible configurations of the printing device. Printing head 28₂ is provided on a console 26₂ and is pivotable by means of a not-illustrated drive, such that the projections 54 on the front panel 22 can be printed. The console 26₂ can, additionally, be displacably movable in the vertical or perpendicular direction and the printing head 28₂ can, for example, be pivotable, via corresponding support on the support arm 56 on the console 26₂, about a vertical or perpendicular axis. Via the thus produced kinematic possibilities, it is possible to imprint the projections 54 in a manner such that the color spray nozzles of the printing heads 28₂ are each at respective predetermined spacings from the outer surface and perpendicular to the outer surface direction, whereby a high quality pattern can be produced.

The printing heads 28₃, which are further illustrated in FIG. 4, are movable in their entirety such that the side surfaces of the front panel 2₂ are imprintable.

As can be directly seen in the heretofore described drawings, each outer surface contour of a front panel 2, including as well, for example, actuation knobs 60 provided on a front panel 2 as shown in FIG. 5, can be imprinted via a printing head 28, which is pivotally mounted for pivoting about a vertical and a horizontal axis on a console 26 (FIG. 2) movable vertically and transversely to the transport belt 12, operating in cooperation with a forward and a backward movement of the transport belt 12.

FIG. 6 shows an example of a decor or, respectively, a pattern, 62, which is applied on an outer surface of a front panel 2 having a grain pattern 4. The grain pattern 4, which can be provided by the wood itself and/or, as the occasion arises, applied via printing, can be variously toned, in respective correspondence with a homogeneous contrast color, in that the outer surface is sprayed or, respectively, imprinted, whereby, in the illustrated example, additionally, a right angled frame is mounted as a decor or, respectively, as a pattern.

FIG. 7 shows a front panel having a base body 62 such as, for example, a base body formed of fiberboard, on which a veneer 66 formed of soft or, respectively, absorbent, wood is mounted. If, in this manner, an absorbent outer surface has liquor drops 66 applied thereto, these flow to the side, in a manner similar to those applied to fibrous or moist papers, and flow into one another, whereby a very pleasing pattern, from an optical perspective, can be produced, if variously colored liquor drops 66 run into each other along their edge regions.

The amounts of the color liquors of the individual liquor drops, which run into one another, can be influenced via the volume of the liquor drops and the type of outer surface.

FIG. 8 shows an example in which, via corresponding printing of individual front panels 2₁₀ through 2₁₅, a complete pattern or, respectively, a complete optical impression, can be produced.

In accordance with FIG. 9, a printing head 28 can be provided with differing color spray nozzles 70₁ through 70₄ charged with variously-colored color liquors, whereby, for example, the printing heads 70₁, 70₂, and 70₃, are charged with colors which, in combination with one another, produce the color black and the printing head 70₄ is charged with a black-colored color liquor.

FIG. 10 shows an embodiment of a printing head 72 which comprises four different printing heads, A, B, C, and X, whereby the printing heads A, B, C are charged with variously-colored color liquors and the printing head X is charged with a wash liquor. The printing heads A, B, C spray their respective color liquors into an intermediate container 74 in which a stirrer 76 is provided and from which an additional printing head 78 is charged.

With the entirety of the printing head 72, the following is achieved:

Via corresponding control of the printing heads A, B, C, the color liquors disposed in the intermediate container 74 can be mixed in any desired mixed color in a programmable manner, the homogeneity of the mixed color being guaranteed by stirrer 76. In this manner, in the printing head 78, the color liquor of each desired color can be extensively and homogeneously sprayed out and applied onto an outer surface.

FIG. 11 shows the printing head 72 shown in FIG. 10 during a cleaning process, if a color change is required. A cleaning liquor supplied by a supply container 80 is sprayed out of the printing head X into the intermediate container 74, after the programmed liquor volume of the intermediate container has been substantially sprayed out and the cleaning liquor is conducted through in a circulation loop 82. The cleaning liquor can be filtered, as shown at 86, if the color liquor is a pigmented color liquor, and can then again be flowed through the intermediate container 74 until no color remains or remnants are present, and thereafter be flowed in its renewed condition to the supply container 80. The reference numerals 88 and 90 refer to valves, the reference numeral 92 refers to a pump. With the arrangement of FIG. 11, color liquors of various homogeneous colors can be sprayed in an environmentally friendly manner with reduced color liquor losses.

Preferably, the previously described imprinting of the outer surfaces of the front panel 2 are subjected to a follow on coating step in which the outer surface is provided with a protective coating, in that this protective coating can be, for example, a leaf or a one or two component synthetic hard enamel or a natural hard enamel coating. The protective coating which is, preferably, transparent, makes the outer surface durable, chemically insensitive, and scratch resistant. It reduces, additionally, the requirements for the UV resistance capability of the applied color liquors or, respectively, tints, with which the imprinting is effected. The protective coating can be configured via spraying, rollers, or other conventional application means.

The described method can be modified in numerous ways. The imprinting need not strictly follow after an ink jet process. The coloring and/or pattern configuration of the outer surfaces can be in accordance with any other process which is, preferably, programmable, so that a high degree of flexibility is provided.

FIG. 12 schematically shows the structure of an entire system for producing groups of front panels which are required for a kitchen unit.

The reference numerals 100 refer to the order inputs which are received in various ways in connection with the ordering of a kitchen unit. An ordered kitchen is characterized via the type and count of its components which comprise closets, shelves, electrical devices, and so forth, all of whose visible sides are all closed off by front panels exhibiting a specific decor characterized, for example, by the outer surface material, the base color, and the pattern with its respective colors.

In response to the receipt of an ordered kitchen unit, an electronically workable data record is assembled in the order input 100 for a group of front panels which are required for an ordered kitchen unit and which are to be assembled together in view of their outer surface characteristics and dimensions. In accordance with whether the required front panels are already in finished condition in a stockage 102 or must be produced in a cutting device 104 with the respective dimensions, the assembled data record goes to the stockage 102 or the cutting device 104.

The assembled together data record in the order input 100 is conducted to a control device 102 having electronic data processing means.

Pre-prepared raw material boards with the required outer surface variety are stored in a material stockage 104 such as, for example, a stockage having synthetic material panels and/or panels with wood veneer.

A form working device 106 is arranged after the material stockage 104 in which the unfinished panels taken from the material stockage 104 are distributed to the cutting devices controlled in conventional numerical control manner or other cutting devices and form panels or, respectively, form pieces, are produced with the predetermined dimensions from the thus distributed panels. The form working device 106 is followed by a form piece stockage 108 in which, in particular, frequently required pre-finished form pieces are stocked.

Further, in the form working device 106, a confection or assembly device 110 is arranged in which the group of form pieces, which belong, for example, to a single order, are assembled together with one another. This group can be arranged in several different ways, depending upon the particular perspective, such as, for example, arranged together immediately after the placement of the order or thereafter, or they can be provided with predetermined special outer surface treatments which are applied as needed. Various outer surfaces can be provided for in a single order.

The assembly device 110 is followed by a pre-handling device 112 in which the form pieces which had been assembled together in the assembly device are pre-handled in a predetermined manner such as, for example, by provision thereof of a prime coat, the mounting of a trimming, the mounting of an edge protection, and so forth.

The pre-handling device 112 is followed by a printing device 114 which, for example, is configured in a manner similar to the printing devices described in the previously mentioned figures of the drawings. A coating device 116 is communicated with the printing device 114 by which the printed and, as the occasion arises, relatively low resistance capable, outer surfaces are coated, for example, with clear enamel which is mechanically especially resistant, cannot be chemically attacked, and/or does not permit UV light to pass through., A product outlet 118 is communicated with the coating device 116 in which the finished components are disposed in readiness for further working thereof to provide a complete kitchen unit, a furniture piece, and so forth.

As seen in FIG. 12, the double arrow indicates the respective flow of material. The connections between the electronic control device 102 and the individual stations are shown by broken lines whereby the respective double arrow indicates that a bi-directional data communication occurs.

In the individual devices or, respectively, stations, manual devices, transport devices, shelf stockages, and so forth, are provided, such being configured in conventional manner and being controlled with a corresponding data record via the control device 2.

Assume that, in the order input 100, an ordered kitchen unit has a corresponding data record assembled therefor. The electronic control device then interrogates the formed component stockage 108 whether corresponding form pieces are already pre-finished. The available form pieces are delivered to the assembly device 110. The form pieces which are not yet pre-finished are created from the raw material boards by the form working device 106 and are delivered to the assembly device 110. Thereafter, the components pass through the pre-treatment, the imprinting, and the coating, to subsequently then be disposed in readiness in the product outlet 118. The pre-handling device 112 and the coating device 116 can basically be configured in a manner similar to the printing device—that is, a transport belt or other transport device is provided in which a respective working station has material delivered thereto, whereby the respective position, geometry, and so forth is sensed by position sensors.

As can be directly seen from the foregoing description, the inventive system makes possible, with the most reduced material stockage (material stockage 104; the form piece stockage 108 is not absolutely necessary), the production of component groups corresponding to an order input in a customer oriented, fully automatic manner or, if follow-on individual manual hand working is required, a substantially automatic manner. It is to be understood that further fully automatic working stations can be communicated with the product outlet 118 at which complete furniture pieces can be assembled from the pre-finished components, whose outer surfaces are already complete.

The described system can be modified in numerous ways. For example, the pre-handling device 112 and the coating device 116 are not necessary. The printing device 114 can work in accordance with various processes. A further working station can be communicated with the assembly device 110 and/or the pre-handling device 112, in which the not yet imprinted components of the component group to be assembled can be produced. The form working device 106 can be complex in its configuration so that the raw material boards need not be cut into components but, instead, can additionally be configured, for example, with three dimensional ornamentation and so forth.

With the illustrated system, replacement pieces for furniture pieces such as, for example, replacement walls for front panels of a kitchen unit, can also be produced, as the system can operate with very good replication capability via the advantageously programmable printing 114 and, as may optionally be provided, with the enhancements of the pre-handling and the coating. The system is extraordinarily flexible and is suitable with respect to the illustrated structural configurations for deployment for the production, especially, of furniture. The individual stations which are networked to the data processing system can also be networked as desired such as, for example, with widely spaced order inputs communicating via different communication ways.

The specification incorporates by reference the disclosure of German priority document 100 31 030.3 filed Jun. 26, 2000 and PCT/EP01/07159 filed Jun. 25, 2001.

The present invention is, of course, in no way restricted to the specific disclosure of the specification and drawings, but also encompasses any modifications within the scope of the appended claims.

Reference Numeral List

| | |
|---|---|
| 2 | front panel |
| 4 | grain pattern |
| 6 | contour lines |
| 8 | transport device |
| 10 | shaft |
| 12 | transport belt |
| 14 | motor |
| 16 | portal |
| 18 | transverse beam |
| 20 | wagon |
| 22 | motor |
| 24 | pinion |
| 26 | console |
| 28 | printing head |
| 30 | sensor |
| 30 | sensor |
| 34 | sensor |
| 36 | computer |
| 38 | keyboard |
| 40 | screen |
| 42 | inputs |
| 44 | outputs |
| 50 | support |
| 52 | axis |
| 54 | projection |
| 56 | support arm |
| 58 | support arm |
| 60 | actuation knob |
| 62 | pattern |
| 64 | base body |
| 66 | liquor drops |
| 70 | color spray nozzle |
| 72 | printing head |
| 74 | intermediate container |
| 76 | stirrer |
| 78 | printing head |
| 80 | supply container |
| 82 | circulation loop |
| 86 | filter |
| 88 | valve |
| 90 | valve |
| 92 | pump |
| 100 | order input |
| 102 | electronic control device |
| 106 | form working device |
| 108 | form piece stockage |
| 110 | assembly device |
| 112 | pre-handling device |
| 114 | printing device |
| 116 | charging device |
| 118 | product outlet |

1. A method for producing planar components with a predetermined outer surface appearance, in particular, front panels of kitchen units, by which method components are printed with a predetermined pattern via a print process programmable to effect the printing of the thus-produced appearance.

2. A method according to claim 1, wherein the outer surfaces to be imprinted are comprised of wood.

3. A method according to claim 1, wherein the outer surfaces to be imprinted are comprised of synthetic material.

4. A method according to one of the claims 1-5, wherein three dimensional outer surfaces are imprinted.

5. A method according to one of the claims 1-5, wherein the print process involves an ink-jet printing process by which color liquor of different colors is sprayed out of different nozzles.

6. A method according to claim 5, wherein a programmable homogeneous color is produced via spraying out from different nozzles a variety of colors as a function of the programmed color to be produced into a collection container wherein the tint of the programmed homogeneous color is created which is thereafter sprayed out of the collection container.

7. A method according to one of the claims 1-6, wherein the outer surface to be imprinted is subjected to a pre-handling step before the imprinting thereof.

8. A method according to one of the claims 1-7, wherein the outer surface having the predetermined pattern imprinted thereon is provided with a transparent coating.

9. An apparatus for producing components with a predetermined outer surface appearance, in particular, front panels of kitchen units, comprising
a base (12) for receipt of the component (2),
a print device (28) oppositely disposed to the component having color spray nozzles adjustably positionable relative to their respective distances from the base, the color spray nozzles for spraying variously colored tints,
a transport device (8) for producing a relative movement between the color spray nozzles and the component,
a sensor device (30, 32, 34) for sensing the positions of the outer surfaces of the component and
an electronic control device (36, 38, 40) for controlling the operation of the transport device (8) and the print device (28) such that a predetermined, programmably configurable pattern is printed on the outer surface of the component (2).

10. An apparatus according to claim 9, wherein the distance between the color spray nozzles and the base is adjustable.

11. An apparatus according to claim 9 or 10, wherein the printing device (28₃) comprises color spray nozzles for imprinting variously oriented outer surfaces of the component (2₂).

12. An apparatus according to one of claims 9-11, wherein a printing head (28₁) longitudinally movably mounted on a support (50) is provided and the support is pivotable about an axis (52) perpendicular to the direction of longitudinal movement of the support.

13. An apparatus according to one of claims 9-12, wherein the printing device includes at least one two-dimensionally pivotable printing head (28₂, 28₃).

14. An apparatus according to one of claims 9-13, wherein the printing device includes a printing head (72) having an intermediate container (74) into which several nozzles (A,B,C,X) spray tint and the intermediate container being operable to supply at least one further nozzle (78).

15. An apparatus according to claim 14, wherein a cleaning device (80, 82) is provided for cleaning of the intermediate container (74).

16. A system for producing groups of components having predetermined appearances, in particular, front panels of kitchen units, comprising
an order input (100) for collecting together electronically processible data records corresponding to a group of components which have been ordered,
a form working device (106) for producing form pieces from component material,
a confection device (110) for assembling together a group of form pieces whose number and forms correspond to the group of components which have been ordered,
a printing device (114) for imprinting the group of form pieces in dependence upon the appearances which have been specified in the order,
a product outlet (118) for discharging the group of imprinted components and
an electronic control device (102) for controlling the operation of at least the printing device as a function of the electronically processible data records.

17. A system according to claim 16, comprising
a pre-handling device (112), controlled by the electronic control device (102), for pre-handling of the outer surfaces of the form pieces before the imprinting thereof.

18. A system according to claim 16 or 17, comprising
a coating device (114), controlled by the electronic control device (102), for coating the imprinted components.
